(19) United States
(12) Patent Application Publication
(10) Pub. No.: US 2009/0244264 A1
(43) Pub. Date: Oct. 1, 2009

(54) COMPOUND EYE PHOTOGRAPHING APPARATUS, CONTROL METHOD THEREFOR , AND PROGRAM

(76) Inventor: Tomonori MASUDA, Kurokawa-gun (JP)

Correspondence Address: BIRCH STEWART KOLASCH & BIRCH, PO BOX 747, FALLS CHURCH, VA, 22040-0747, US

(21) Appl. No.: 12/410,857

(22) Filed: Mar. 25, 2009

(30) Foreign Application Priority Data
Mar. 26, 2008 (JP) 079635/2008

(51) Int. Cl. H04N 13/02

(52) U.S. Cl. 348/47; 348/E13.074

(57) ABSTRACT

A compound eye photographing apparatus, including a plurality of photographing units for photographing a subject at a plurality of photographing positions to obtain images of the subject, a subject detection unit for detecting a predetermined subject from the images obtained by the photographing units, and a photographing control unit for causing a particular one of the plurality of photographing units to perform photographing, determining whether or not the predetermined subject is included in the image obtained by the particular photographing unit, and causing another photographing unit other than the particular photographing unit to start photographing only when the determination is positive.

### BACKGROUND OF THE INVENTION

1. Field of the Invention

The present invention relates to a compound eye photographing apparatus for photographing a subject at a plurality of different photographing positions and a control method of the same. The invention also relates to a computer readable recording medium on which is recorded a program for causing a computer to perform the control method of the compound eye photographing apparatus.

2. Description of the Related Art

A method for generating a distance image that represents a stereoscopic shape of a subject is proposed. In the method, the subject is photographed by a compound eye camera having a plurality of cameras, then corresponding points, which are pixels corresponding to each other, between a plurality of images (a base image obtained by a base camera and a reference image obtained by a reference camera) obtained by the photographing are searched for (stereo matching), and the distance from the base camera or reference camera to the point on the subject corresponding to the pixel is measured by applying the principle of triangulation to the positional difference (parallax) between the pixel in the base image and the pixel in the reference image corresponding to each other, thereby generating a distance image.

In particular, a method for calculating an inter-vehicular distance is proposed as described, for example, in Japanese Unexamined Patent Publication No. 10(1998)-047954. In the method, a second vehicle is extracted from a plurality of images obtained by a compound eye camera installed in a first vehicle, and a distance measurement is performed on the extracted vehicle by a stereo matching method, thereby calculating an inter-vehicle distance between the first and second vehicles.

In the compound eye camera described in Japanese Unexamined Patent Publication No. 10(1998)-047954, however, photographing by two cameras and vehicle detection from the two images obtained by the photographing are performed constantly. That is, the photographing and subject detection are performed even when no vehicle is in the photographing range of the cameras, so that the photographing and processing of subject detection are wasted.

The present invention has been developed in view of the circumstances described above, and it is an object of the present invention to eliminate waste in a compound eye photographing apparatus and enable efficient photographing of subjects.

### SUMMARY OF THE INVENTION

A first photographing apparatus of the present invention is an apparatus including:

a plurality of photographing unit for photographing a subject at a plurality of photographing positions to obtain images of the subject;

a subject detection unit for detecting a predetermined subject from the images obtained by the photographing unit; and

a photographing control unit for causing a particular one of the plurality of photographing unit to perform photographing, determining whether or not the predetermined subject is included in the image obtained by the particular photographing unit, and causing another photographing unit other than the particular photographing unit to start photographing only when the determination is positive.

In the first photographing apparatus of the present invention, the subject detection unit may be a unit that detects the predetermined subject from the image obtained by the another photographing unit, and the photographing control unit may be a unit that determines, after the photographing by the another photographing unit is started, whether or not the predetermined subject is included in the image obtained by at least either of the particular photographing unit and the another photographing unit, and terminates the photographing by the another photographing unit if the determination is negative.

A second photographing apparatus of the present invention is an apparatus including:

a plurality of photographing unit for photographing a subject at a plurality of photographing positions to obtain images of the subject;

a subject detection unit for detecting a predetermined subject from the images obtained by the photographing unit; and

a detection control unit for causing the plurality of photographing unit to perform photographing, determining whether or not the predetermined subject is included in the image obtained by a particular one of the plurality of photographing unit, and only when the determination is positive, causing the subject detection unit to start detecting the predetermined subject from the image obtained by another photographing unit other than the particular photographing unit.

In the second photographing apparatus according to the present invention, the detection control unit may be a unit that determines, after detection of the predetermined subject from the image obtained by the another photographing unit is started, whether or not the predetermined subject is included in the image obtained by at least either one the particular photographing unit and the another photographing unit, and terminates the detection of the particular subject from the image obtained by the another photographing unit if the determination is negative.

A first photographing apparatus control method of the present invention is a method for controlling a photographing apparatus having a plurality of photographing unit for photographing a subject at a plurality of photographing positions to obtain images of the subject and a subject detection unit for detecting a predetermined subject from the images obtained by the photographing unit, the method including the steps of:

performing photographing by a particular one of the plurality of photographing unit;

determining whether or not the predetermined subject is included in the image obtained by the particular photographing unit; and

start photographing by another photographing unit other than the particular photographing unit only when the determination is positive.

A second photographing apparatus control method of the present invention is a method for controlling a photographing apparatus having a plurality of photographing unit for photographing a subject at a plurality of photographing positions to obtain images of the subject and a subject detection unit for detecting a predetermined subject from the images obtained by the photographing unit, the method including the steps of:

performing photographing by the plurality of photographing unit;

determining whether or not the predetermined subject is included in the image obtained by a particular one of the plurality of photographing unit; and

start detecting the predetermined subject from the image obtained by another photographing unit other than the particular photographing unit only when the determination is positive.

Each of the first and second photographing apparatus control methods of the present invention may be provided as a program recorded on a computer readable recording medium for causing a computer to perform the method.

According to the first photographing apparatus and the control method therefore, photographing is performed by a particular one of a plurality of photographing unit, a determination is made whether or not a predetermined subject is included in the image obtained by the particular photographing unit, and photographing by another photographing unit other than the particular photographing unit is started only when the determination is positive. Here, when photographing a common predetermined subject, if the predetermined subject is not included in the image obtained by the particular photographing unit, then the predetermined subject is not included also in the image obtained by another photographing unit.

According to the first photographing apparatus and the control method therefore, unless the predetermined subject is included in the image obtained by the particular imaging unit, another photographing unit does not take a photograph not including the predetermined subject, so that wasteful operation of the another photographing unit may be prevented. Further, processing for detecting the predetermined subject from the image obtained by the another photographing unit is not performed, so that wasteful processing of detecting the predetermined subject may be prevented.

Further, after photographing is started by the another photographing unit, a determination is made whether or not the predetermined subject is included in the image obtained by at least either of the particular photographing unit and the another photographing unit, and if the determination is negative, the photographing by the another photographing unit is terminated. That is, although the photographing by the another photographing unit has once been started, if the predetermined subject is not included in the image, the photographing by the another photographing unit is terminated, so that wasteful photographing operation and processing of detecting the predetermined subject may be prevented.

According to the second photographing apparatus and the control method therefore, photographing is performed by a plurality of photographing unit, a determination is made whether or not a predetermined subject is included in the image obtained by a particular photographing unit, and only when the determination is positive, detection of the predetermined subject from the image obtained by another photographing unit other than the particular photographing unit is started.

According to the second photographing apparatus and the control method, therefore, unless the predetermined subject is detected from the image obtained by the particular imaging unit, processing of detecting the predetermined subject from the image obtained by the another photographing unit is not performed, so that wasteful processing of detecting the predetermined subject may be prevented.

Further, after detection of the predetermined subject is started from the image obtained by the another photographing unit, a determination is made whether or not the predetermined subject is included in the image obtained by at least either of the particular photographing unit and the another photographing unit, and if the determination is negative, the detection of the predetermined subject from the another photographing unit is terminated. That is, although the detection of the predetermined subject has once been started, if the predetermined subject is not detected from the image, the detection of the predetermined subject from the another photographing unit is terminated, so that wasteful processing of detecting the predetermined subject may be prevented.

### BRIEF DESCRIPTION OF THE DRAWINGS

FIG. 1 is a schematic block diagram of a compound eye photographing apparatus according to a first embodiment of the present invention, illustrating a configuration thereof.

FIG. 2 is a flowchart illustrating processing performed in the first embodiment.

FIG. 3 is a schematic block diagram of a compound eye photographing apparatus according to a second embodiment of the present invention, illustrating a configuration thereof.

FIG. 4 is a flowchart illustrating processing performed in the second embodiment.

FIG. 5 illustrates a composite image.

### DESCRIPTION OF THE PREFERRED EMBODIMENTS

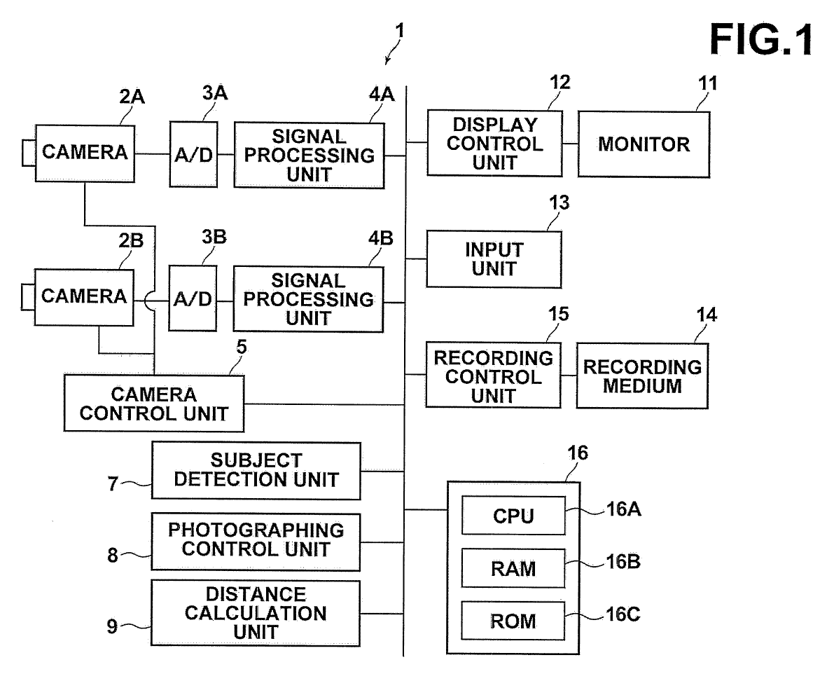

Hereinafter, exemplary embodiments of the present invention will be described with reference to the accompanying drawings. FIG. 1 is a schematic block diagram of a compound eye photographing apparatus according to a first embodiment of the present invention, illustrating a configuration thereof. As illustrated in FIG. 1, the compound eye photographing apparatus 1 according to the first embodiment of the present invention includes two cameras 2A, 2B, A/D conversion units 3A, 3B, signal processing units 4A, 4B, and camera control unit 5.

Each of cameras 2A, 2B is provided to obtain an image for calculating a distance value. It has an optical system including a taking lens and an imaging device, such as a CCD or the like, and drive-controlled by camera control unit 5 in focus operation and zoom operation using the taking lens, exposure, charge readout timing from the imaging device, and the like. Cameras 2A, 2B are disposed at a predetermined distance, and a baseline length, which is the distance between cameras 2A, 2B, and an angle of convergence, which is an angle formed by the lines of sight of both cameras when focusing on a subject, can be changed. In the present embodiment, the description will be made on the assumption that cameras 2A, 2B photograph motion pictures, but the cameras may be those that photograph through images until a photographing operation is performed and when the photographing operation is performed, photograph still images at that timing. Where motion pictures are photographed, images SA, SB correspond to one frame of the respective motion pictures.

A/D conversion units 3A, 3B convert images SA, SB obtained by respective cameras 2A, 2B by photographing from analog data to digital data.

Signal processing units 4A, 4B perform parallelizing processing for parallelizing two images SA, SB, as well as performing correction processing for correcting variations in the sensitivity distributions of image data and distortions of the optical systems. The signal processing units 4A, 4B further perform image processing on the parallelized images, such as white balance adjustment, tone correction, sharpness correction, color correction, and the like. Note that reference symbols SA, SB used for images prior to the processing by signal processing units 4A, 4B will also be used for the processed images. Further, the correction processing, parallelizing processing, and image processing are hereinafter collectively referred to as signal processing.

The compound eye photographing apparatus 1 further includes subject detection unit 7 and photographing control unit 8.

Subject detection unit 7 detects a predetermined subject from images SA, SB (whether before or after the signal processing) obtained by cameras 2A, 2B respectively by photographing. In the present embodiment, a face is used as the predetermined subject. As for the method for detecting a face from an image, any method may be used, such as template matching method, method using a face discriminator obtained through machine learning using multitudes of sample images, method that extracts a rectangular region having a skin color and enclosing a face contour shape in an image as a face, method that extracts a region having a face contour shape as a face, or the like. Where motion pictures are photographed, images SA, SB correspond to one frame of the respective motion pictures. As such, the face detection and the subsequent processing may be performed on all of the frames or by skipping some of them.

Photographing control unit 8 drive controls cameras 2A, 2B such that photographing is performed first by camera 2A and when a face is detected from image SA obtained by camera 2A by the photographing, then photographing is started by camera 2B. Detailed processing performed by photographing control unit 8 will be described later.

Compound eye photographing apparatus further includes distance calculation unit 9.

Distance calculation unit 9 is provided to measure the distance from each of cameras 2A, 2B to a subject included in the photographing ranges of cameras 2A, 2B. First, the unit obtains corresponding points corresponding to each other in images SA, SB obtained by cameras 2A, 2B using a stereo matching method. For example, distance calculation unit 9 obtains the corresponding points by cutting out a partial matrix (e.g., 3×3 pixels) from each of images SA, SB and calculating a correlation value thereof. Then, using the obtained corresponding points, baseline length between cameras 2A, 2B, convergence angle and zoom magnification of cameras 2A, 2B, the unit calculates a distance value representing the distance to a common subject included in images SA, SB based on the principle of triangulation. More specifically, with respect to all of the pixels common to images SA, SB, corresponding points between images SA, SB are detected on a pixel-by-pixel basis to calculate a parallax, which is the difference between the corresponding points, then the distance value is calculated based on the parallax, and distance image SR in which each pixel has a distance value is generated. A stereoscopically viewable stereoscopic image may also be generated from images SA, SB based on the parallax.

Compound eye photographing apparatus 1 further includes monitor 11, such as a liquid crystal display, for displaying images SA, SB, and distance image SR; display control unit 12 for controlling display of various types of information on monitor 11; input unit 13 which includes an arrow key, operation buttons, a zoom lever, a release button, and the like; and recording control unit 15 for recording distance image SR on recording medium 14, such as a memory card or the like. Still further, compound eye photographing apparatus 1 includes overall control unit 16 which includes CPU 16A, RAM 16B which serves as a work area, and ROM 16C having stored therein programs and various setting values used in apparatus 1.

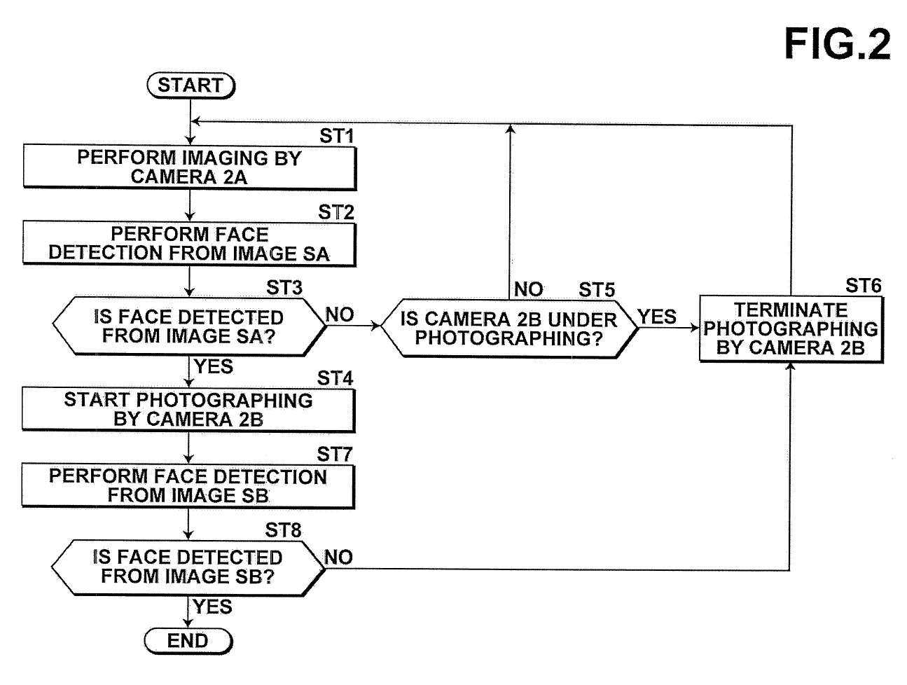

Processing performed in the first embodiment will now be described. FIG. 2 is a flowchart illustrating the processing performed in the first embodiment. Compound eye photographing apparatus 1 according to the first embodiment has distinctive features in controlling the operation of cameras 2A, 2B, so that only the processing for drive controlling cameras 2A, 2B will be described here. First, overall control unit 16 initiates the processing in response to an instruction to start photographing issued by power-on operation or the like, and photographing control unit 8 causes camera 2A to perform photographing (step ST1). Then, subject detection unit 7 detects a face from image SA obtained by camera 2A by the photographing (step ST2).

Next, photographing control unit 8 determines if a face is detected from image SA (step ST3). If step ST3 is positive, the unit causes camera 2B to start photographing (step ST4). If step ST3 is negative, photographing control unit 8 determines if camera 2B is under photographing (step ST5). If step ST5 is negative, the processing returns to step ST1 and repeats the steps from step ST1 onward, while if step ST5 is positive, the photographing operation by camera 2B is terminated (step ST6) and the processing returns to step ST1.

In the mean time, following step ST4, subject detection unit 7 detects a face from image SB obtained by camera 2B by the photographing (step ST7). Then, photographing control unit 8 determines if a face is detected from image SB (step ST8), and if step ST8 is positive, the processing returns to step ST1, while if step ST8 is negative, the processing proceeds to step ST6 to terminate the photographing operation by camera 2B and returns to step ST1.

As described above, in the first embodiment, photographing is performed by camera 2A first, then a determination is made if a face is detected from image SA obtained by camera 2A, and only when the determination is positive, photographing by camera 2B is started. Here, when photographing a face which is a common subject of cameras 2A, 2B, if a face is not included in image SA obtained by camera 2A, then the face is not included also in image SB obtained by camera 2B. According to the first embodiment, unless a face is included in image SA, camera 2B does not take a photograph not including the face, so that wasteful operation of camera 2B is prevented. Further, processing for detecting a face from image SB obtained by camera 2B is not required, so that wasteful processing of face detection may be prevented.

Further, after photographing by camera 2B is started, if either of images SA, SB obtained by camera 2A or 2B does not include a face, the photographing by camera 2B is terminated. That is, although the photographing by camera 2B has once been started, if either of images SA, SB does not include a face, the photographing by camera 2B is terminated, so that wasteful photographing operation and face detection processing may be prevented.

In the first embodiment, photographing by camera 2B is terminated when either of images SA, SB obtained by camera 2A or 2B does not include a face. But an arrangement may be adopted in which photographing by camera 2B is terminated when both images SA, SB obtained by cameras 2A, 2B do not include a face.

Further, in the first embodiment, an arrangement may be adopted in which after step ST3 is positive and photographing by camera 2B is started in step ST4, the processing is returned immediately to step ST1 without performing step ST7.

Still further, in the first embodiment, compound eye photographing apparatus 1 includes two cameras 2A, 2B, but the apparatus may include three or more cameras. In this case, a particular one of the cameras performs photographing, and a determination is made if a face is included in the image obtained by the particular one of the cameras, and if the determination is positive, photographing by all of the other cameras is started.

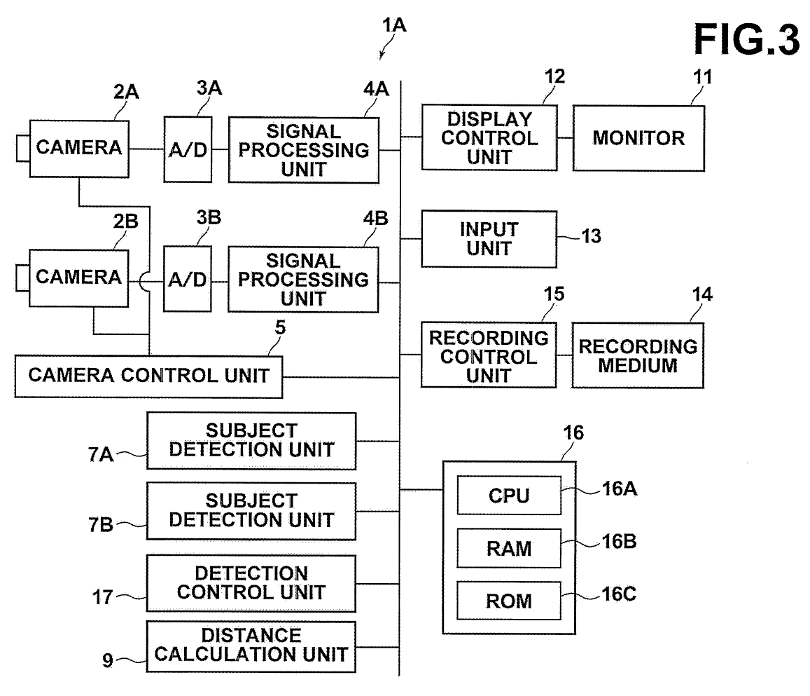

Next, a second embodiment of the present invention will be described. FIG. 3 is a schematic block diagram of a compound eye photographing apparatus according to the second embodiment of the present invention, illustrating a configuration thereof. Components identical to those in the first embodiments are given the same reference symbols and will not be elaborated upon further here.

Compound eye photographing apparatus 1A according to the second embodiment differs from the first embodiment in that it includes subject detection units 7A, 7B for detecting a face, which is a subject of photographing, and detection control unit 17 for controlling the face detection, and photographing is performed by cameras 2A, 2B and only when a face is detected from image SA obtained by camera 2A by the photographing, a face is detected from image SB obtained by camera 2B by the photographing.

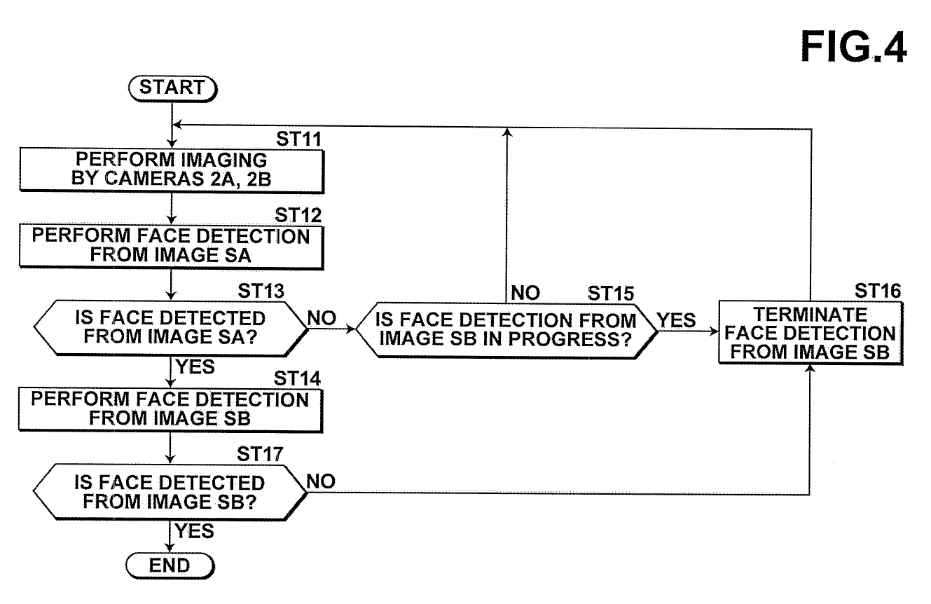

Processing performed in the second embodiment will now be described. FIG. 4 is a flowchart illustrating the processing performed in the second embodiment. Compound eye photographing apparatus 1A according to the second embodiment has distinctive features in controlling face detection from images SA, SB obtained by cameras 2A, 2B, so that only the processing for controlling face detection from images SA, SB will be described here. First, overall control unit 16 initiates the processing in response to an instruction to start photographing issued by power-on operation or the like, and photographing control unit 8 causes cameras 2A, 2B to perform photographing (step ST11). Then, subject detection unit 7A detects a face from image SA obtained by camera 2A by the photographing (step ST12).

Next, photographing control unit 8 determines if a face is detected from image SA (step ST13). If step ST13 is positive, subject detection unit 7B detects a face from image SB obtained by camera 2B by the photographing in response to an instruction from detection control unit 17 (step ST14). If step ST13 is negative, detection control unit 17 determines if subject detection unit 7B is under detection of a face from image SB obtained by camera 2B (step ST15). If step ST15 is negative the processing returns to step ST11 and repeats the steps from step ST11 onward, while if step ST15 is positive, the face detection by subject detection unit 7B is terminated based on an instruction from detection control unit 17 (step ST16) and the processing returns to step ST11.

In the mean time, following step ST14, detection control unit 17 determines if a face is detected from image SB (step ST17), and if step ST17 is positive, the processing returns to step ST11, while if step ST17 is negative the processing proceeds to step ST16 to determinate the face detection from image SB and returns to step ST11.

As described above, in the second embodiment, photographing is performed by both cameras 2A, 2B, then a determination is made if a face is detected from image SA obtained by camera 2A, and only when a face is detected from image SA, face detection from image 2B obtained by camera 2B is started by subject detection unit 7B. Here, when photographing a face which is a common subject of cameras 2A, 2B, if a face is not included in image SA obtained by camera 2A, then the face is not included also in image SB obtained by camera 2B. According to the second embodiment, unless a face is included in image SA, face detection from image SB obtained by camera 2B is not started, so that wasteful processing of face detection is may be prevented.

Further, after face detection from image SB is started, if either of images SA, SB obtained by camera 2A or 2B does not include a face, the face detection from image SB is terminated. That is, although face detection from image SB has once been started, if either of images SA, SB does not include a face, the face detection from image SB is terminated, so that wasteful processing of face detection may be prevented.

In the second embodiment, face detection from image SB is terminated when either of images SA, SB obtained by camera 2A or 2B does not include a face. But an arrangement may be adopted in which face detection from image SB is terminated when both images SA, SB obtained by cameras 2A, 2B do not include a face.

Further, in the second embodiment, an arrangement may be adopted in which after step ST13 is positive and face detection from image SB is started in step ST14, the processing is returned immediately to step ST11 without performing step ST17.

Still Further, in the second embodiment, a face is detected from respective images SA, SB obtained by cameras 2A, 2B by two subject detection units 7A, 7B, but an arrangement may be adopted in which only one subject detection unit 7 is provided as in the first embodiment, and a face is detected from respective images SA, SB obtained by cameras 2A, 2B are detected by subject detection unit 7.

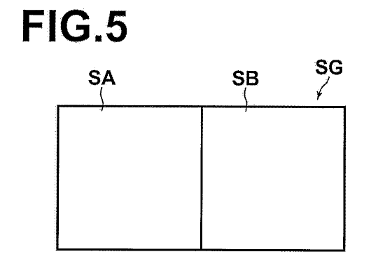

Further, in the second embodiment, a face is detected separately from images SA, SB, but an arrangement may be adopted in which composite image SG is generated by combining images SA, SB side by side, as illustrated in FIG. 5, and a face is detected from composite image SG. In this case, step ST12 is performed on the area corresponding to image SA of composite image SG, and step ST14 is performed on the area corresponding to image SB of composite image SG.

Still further, in the second embodiment, compound eye photographing apparatus 1A includes two cameras 2A, 2B, but the apparatus may include three or more cameras. In this case, a determination is made if a face is detected from an image obtained by a particular one of the cameras, and if the determination is positive, face detection from images obtained by all of the other cameras is started.

In the first and second embodiments, a predetermined subject is a face, but it will be appreciated that a subject other than a face, such as a vehicle, building, or the like, can be the detection target.

So far embodiments of the present invention have been described, but a program for causing a computer to function as units corresponding to subject detection units 7A, 7B, imaging control unit 8, and detection control unit 17, thereby performing processing like that shown in FIGS. 2 and 4 is another embodiment of the present invention. Further, a computer readable recording medium on which is recorded such a program is still another embodiment of the present invention.

What is claimed is:

1. A photographing apparatus comprising:
a plurality of photographing unit for photographing a subject at a plurality of photographing positions to obtain images of the subject;
a subject detection unit for detecting a predetermined subject from the images obtained by the photographing unit; and
a photographing control unit for causing a particular one of the plurality of photographing unit to perform photographing, determining whether or not the predetermined subject is included in the image obtained by the particular photographing unit, and causing another photographing unit other than the particular photographing unit to start photographing only when the determination is positive.

2. The photographing apparatus as claimed in claim 1, wherein:
the subject detection unit is a unit that detects the predetermined subject from the image obtained by the another photographing unit; and
the photographing control unit is a unit that determines, after the photographing by the another photographing unit is started, whether or not the predetermined subject is included in the image obtained by at least either of the particular photographing unit and the another photographing unit, and terminates the photographing by the another photographing unit if the determination is negative.

3. A photographing apparatus comprising:
a plurality of photographing unit for photographing a subject at a plurality of photographing positions to obtain images of the subject;
a subject detection unit for detecting a predetermined subject from the images obtained by the photographing unit; and
a detection control unit for causing the plurality of photographing unit to perform photographing, determining whether or not the predetermined subject is included in the image obtained by a particular one of the plurality of photographing unit, and only when the determination is positive, causing the subject detection unit to start detecting the predetermined subject from the image obtained by another photographing unit other than the particular photographing unit.

4. The photographing apparatus as claimed in claim 3, wherein the detection control unit is a unit that determines, after detection of the predetermined subject from the image obtained by the another photographing unit is started, whether or not the predetermined subject is included in the image obtained by at least either of the particular photographing unit and the another photographing unit, and terminates the detection of the particular subject from the image obtained by the another photographing unit if the determination is negative.

5. A photographing apparatus control method for controlling a photographing apparatus having a plurality of photographing unit for photographing a subject at a plurality of photographing positions to obtain images of the subject and a subject detection unit for detecting a predetermined subject from the images obtained by the photographing unit, the method comprising the steps of:
performing photographing by a particular one of the plurality of photographing unit;
determining whether or not the predetermined subject is included in the image obtained by the particular photographing unit; and
start photographing by another photographing unit other than the particular photographing unit only when the determination is positive.

6. A photographing apparatus control method for controlling a photographing apparatus having a plurality of photographing unit for photographing a subject at a plurality of photographing positions to obtain images of the subject and a subject detection unit for detecting a predetermined subject from the images obtained by the photographing unit, the method comprising the steps of:
performing photographing by the plurality of photographing unit;
determining whether or not the predetermined subject is included in the image obtained by a particular one of the plurality of photographing unit; and
start detecting the predetermined subject from the image obtained by another photographing unit other than the particular photographing unit only when the determination is positive.

7. A computer readable recording medium on which is recorded a program for causing a computer to perform a photographing apparatus control method for controlling a photographing apparatus having a plurality of photographing unit for photographing a subject at a plurality of photographing positions to obtain images of the subject and a subject detection unit for detecting a predetermined subject from the images obtained by the photographing unit, the program comprising the steps of:
performing photographing by a particular one of the plurality of photographing unit;
determining whether or not the predetermined subject is included in the image obtained by the particular photographing unit; and
start photographing by another photographing unit other than the particular photographing unit only when the determination is positive.

8. A computer readable recording medium on which is recorded a program for causing a computer to perform a photographing apparatus control method for controlling a photographing apparatus having a plurality of photographing unit for photographing a subject at a plurality of photographing positions to obtain images of the subject and a subject detection unit for detecting a predetermined subject from the images obtained by the photographing unit, the program comprising the steps of:
performing photographing by the plurality of photographing unit;
determining whether or not the predetermined subject is included in the image obtained by a particular one of the plurality of photographing unit; and
start detecting the predetermined subject from the image obtained by another photographing unit other than the particular photographing unit only when the determination is positive.
